(19) United States
(12) Patent Application Publication
(10) Pub. No.: US 2007/0055601 A1
(43) Pub. Date: Mar. 8, 2007

(54) Methods for enrolling participants in benefit plans

(76) Inventors: Luanne Marie Inderski, Urbandale, IA (US); Jennifer S. Daniel, Johnston, IA (US); Andrew Jeffrey Frantz, Des Moines, IA (US); Karla Rae Gierstorf, West Des Moines, IA (US); Scott Alan Heiser, Johnston, IA (US); Angela Marie Johnson, Des Moines, IA (US); Susan Shissler, Altoona, IA (US); Bradley Allen Tenpas, Johnston, IA (US)

Correspondence Address: MICHAEL BEST & FRIEDRICH, LLP, 100 E WISCONSIN AVENUE, MILWAUKEE, WI, 53202, US

(21) Appl. No.: 11/210,463

(22) Filed: Aug. 24, 2005

(51) Int. Cl. G06Q 40/00

(52) U.S. Cl. 705/36 R

(57) ABSTRACT

Methods and systems of enrolling a participant in at least one benefit plan. A method of enrolling at least one participant in at least one benefit plan including electronically receiving benefit plan information from a plan sponsor, electronically providing benefit plan information to the at least one participant, receiving benefit plan need information from the at least one participant, receiving needs priority information from the at least one participant, and electronically providing benefit plan suggestion information to the at least one participant.

### FIELD OF THE INVENTION

Embodiments of the invention generally relate to methods and systems of enrolling participants in a benefit plan, such as a voluntary benefit plan.

### BACKGROUND OF THE INVENTION

With the rising costs of benefit plans, such as medical benefits, more and more plan sponsors (e.g., employers) are changing benefit plans to a voluntary basis and making participants (e.g., employees) responsible for their own benefit selections and/or funding. When selecting benefits, participants are often overwhelmed and unknowledgeable about benefit plan offerings, benefit plan costs, and their benefit plan needs.

### SUMMARY OF THE INVENTION

Some embodiments of the invention provide a method of enrolling at least one participant in at least one benefit plan including electronically receiving benefit plan information from a plan sponsor, electronically providing benefit plan information to the at least one participant, receiving benefit plan need information from the at least one participant, receiving needs priority information from the at least one participant, and electronically providing benefit plan suggestion information to the at least one participant.

Additional embodiments provide a computer readable medium including instructions for enrolling at least one participant in at least one benefit plan. The instructions including receiving benefit plan information from a plan sponsor, displaying benefit plan information to the at least one participant, receiving benefit plan need information from the at least one participant, receiving needs priority information from the at least one participant, and displaying benefit plan suggestion information to the at least one participant.

Another embodiment provides a benefit enrollment tool including an input/output module, a memory module and a processor. The input/output module can obtain benefit plan information, participant information, benefit need information, and needs priority information from at least one external source and can provide benefit plan suggestion information to at least one external source. The memory module can store the benefit plan information, the participant information, the benefit need information, the needs priority information, and instructions for determining benefit plan suggestion information. The processor can obtain the benefit plan information, the participant information, the benefit need information, the needs priority information, and the instructions for determining benefit plan suggestion information, can execute the instructions for determining benefit plan suggestion information using at least one of the benefit plan information, the participant information, the benefit need information, and the needs priority information as input, and can generate the benefit plan suggestion information.

### BRIEF DESCRIPTION OF THE DRAWINGS

FIG. 1 illustrates a benefit enrollment tool according to one embodiment of the invention.

FIGS. 2A and 2B illustrate a method for using the benefit enrollment tool of FIG. 1 to enroll a participant in a benefit plan according to one embodiment of the invention.

FIGS. 3-15 illustrate user interfaces of the benefit enrollment tool of FIG. 1 according to one embodiment of the invention.

FIG. 16 illustrates a referral worksheet according to one embodiment of the invention.

FIG. 17 illustrates the benefit enrollment tool of FIG. 1 connected to other systems, tools, and applications according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and software components or modules. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

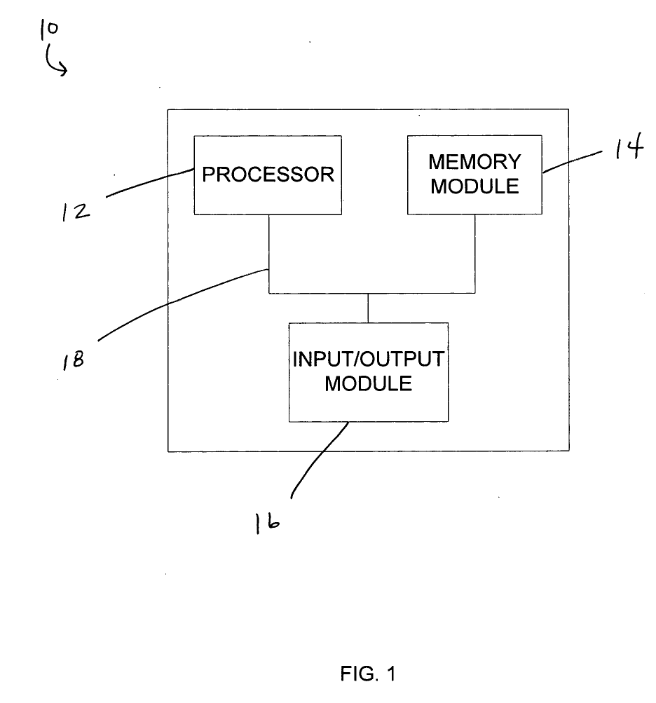

FIG. 1 illustrates a benefit enrollment tool 10 according to one embodiment of the invention. The benefit enrollment tool 10 can be used to enroll a participant in one or more benefit plans. In some embodiments, the benefit enrollment tool 10 can be used to enroll a participant in one or more voluntary benefit plans, such as a life insurance plan, a short term disability plan, a long term disability plan, a dental plan, a qualified defined benefit retirement plan, a qualified defined contribution retirement plan, a nonqualified retirement plan, a stock ownership plan, a profit sharing retirement plan, a pension plan, a salary reduction retirement plan, an individual retirement account plan, a health savings account plan, a supplemental health insurance plan, a pharmaceutical plan, a vision plan, a long term healthcare plan, a flexible spending account plan, a transportation compensation plan, a childcare plan, a tenure plan, a child support plan, an alimony plan, an automobile insurance plan, a homeowner's insurance plan, a renters insurance plan, a salary reduction plan, a college savings plan, a mutual fund investment plan, a loan, a mortgage, a savings account, a checking account, a stock, a mutual fund, a trust plan, a future contract plan, an option plan, a certificate of deposit, a bond, a credit card account, an annuity, and a money market account.

As shown in FIG. 1, the benefit enrollment tool 10 can include a processor 12, a memory module 14, and an input/output module 16. The processor 12, the memory module 14, the input/output module 16 can be connected by a connection, such as a bus 18.

The processor 12 can include one or more microprocessors, macroprocessors, application specific integrated circuits (“ASIC”), or a combination thereof. In some embodiments, the processor 12 can be configured to fetch instructions and/or data from the memory module 14 via the bus 18 and execute the instructions in order to process the data. The memory module 14 can include non-volatile memory, such as one or more forms of ROM, one or more disk drives, RAM, other memory, or combinations of the foregoing. In some embodiments, the memory module 14 can include instructions for processing benefit plan information, participant information, additional benefit plan information, benefit need information, and/or needs priority information in order to generate benefit plan suggestion information and/or enroll a participant in a benefit plan.

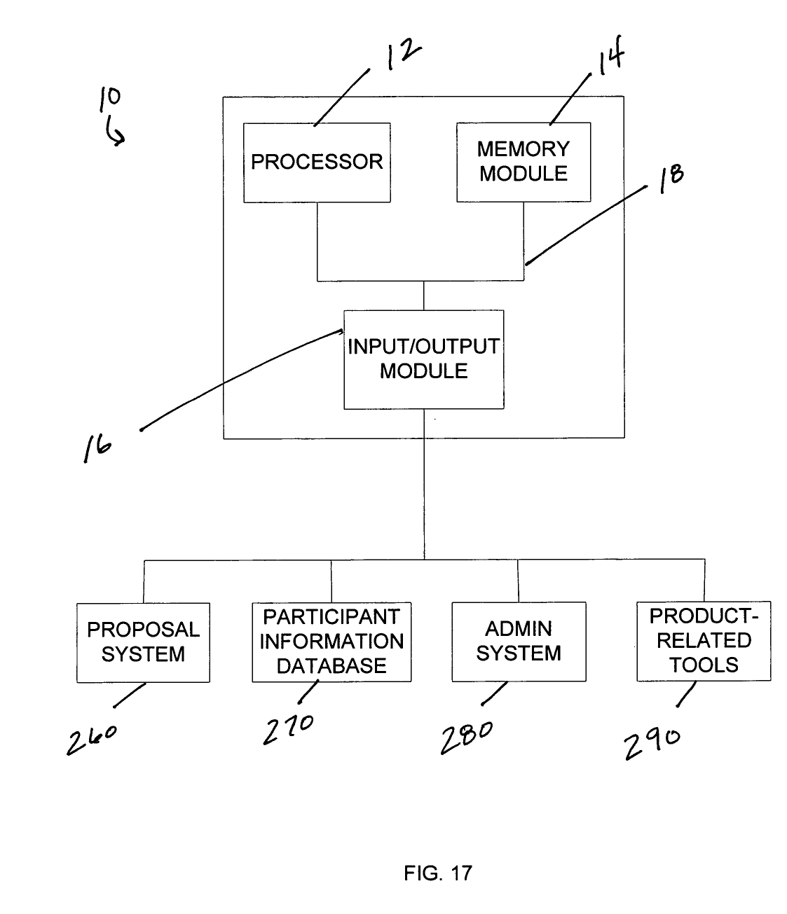

The input/output module 16 can include one or more connections or interfaces to external sources, such as devices and systems, in order to obtain instructions and/or data. For example, the input/output module 16 can include a connection to a network, such as a local area network (“LAN”) or the Internet. In some embodiments, the input/output module 16 can include a connection to a memory module, such as a disk drive or a database external to the benefit enrollment tool 10. The input/output module 16 can include connections to one or more input devices, such as a cursor control device (i.e., a keyboard, a mouse, a joystick, etc.) and/or one or more output devices, such as a monitor or a printing mechanism. FIG. 17, described below, illustrates additional devices and systems that can be connected to the benefit enrollment tool 10 through the input/output module 16.

The input/output module 16 can obtain instructions and/or data and can provide the instructions and/or data to the processor 12. In some embodiments, the input/output module 16 can obtain instructions and/or data and store the instructions and/or data in the memory module 14. The processor 12 can then obtain the instructions and/or data from the memory module 14.

In some embodiments, the processor 12, the memory module 14, and/or the input/output module 16 can be located on a workstation, such as a personal computer. In other embodiments, the processor 12, the memory module 14, and/or the input/output module 16 can be located on a server. For example, a user can supply information from a workstation over a network, such as a LAN or the Internet, to the benefit enrollment tool 10 located on a server. The benefit enrollment tool 10 can process the data and return data to the user at the workstation.

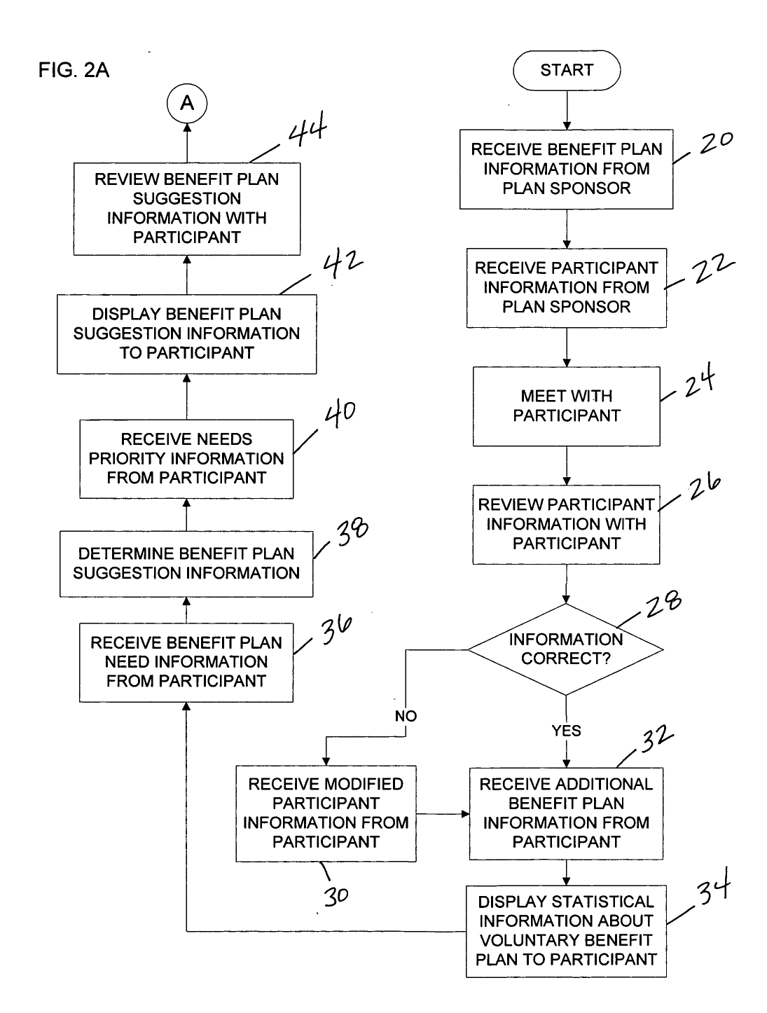

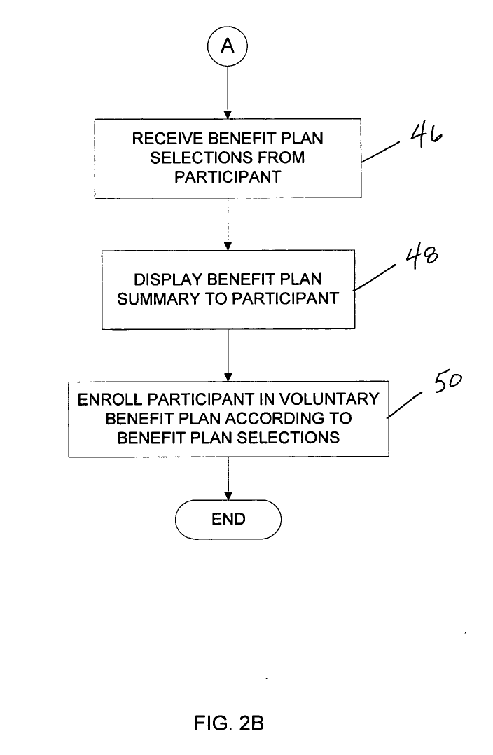

FIGS. 2A and 2B illustrate a method of operating the benefit enrollment tool 10 according to one embodiment of the invention. In some embodiments, a plan provider can operate or provide the benefit enrollment tool 10 in order to enroll a participant in one or more benefit plans. The benefit plans available for enrollment through the benefit enrollment tool 10 can include benefit plans offered by the plan provider and benefit plans offered by a second or separate plan provider. As shown in FIG. 2A, the method can begin by receiving benefit plan information from a plan sponsor (step 20). The benefit plan information can include information about benefit plans offered by the plan sponsor (e.g., an employer) to one or more participants (e.g., employees). In some embodiments, the plan sponsor can offer one or more base or core benefit plans, such as a medical or healthcare plan, and one or more voluntary benefit plans, such as a life insurance plan, a retirement plan, an accidental death and disbursement (“AD&D”) plan, a short term disability plan, a long term disability plan, a vision plan, and/or a dental plan. For each plan, the benefit plan information can indicate benefit coverage, benefit amounts, benefit costs, benefit options, etc.

In some embodiments, the plan sponsor can provide participant information (step 22). The participant information can include information about the one or more participants, such as name, address, date of birth, date of hire, spouse information, and dependent information. Table 1, below, lists participant information provided by the plan sponsor according to one embodiment of the invention.

TABLE 1

| Data Needed | Description | Example |
|---|---|---|
| Last Name | Participant's last name. If there is a suffix or a surname, enter | Smith Jr |
| | last name, space, and suffix or surname. | Jones III |
| First Name | Participant's first name. If there is a middle name, enter first | John Alan |
| | name, space, and middle name. | |
| SSN | Participant's Social Security Number. Enter 9 digits. Do not | 999999999 |
| | use spaces or dashes. | |
| PA DOB | Participant's date of birth. Enter as MM/DD/YYYY. | 01/15/1970 |
| PA Gender | Participant's gender. Enter “M” for male or “F” for female. | F |
| Salary | Participant's salary. Do not include dollar sign or commas. | 50000 |
| Salary Mode | Frequency salary is earned. H = Hourly, W = Weekly, B = Bi- | H |
| | Weekly, M = Monthly, and A = Annually. | |
| Hours Per Week | Indicate participant's scheduled hours per week if salary mode | 35 |
| | is hourly and participant works less than 40 hours a week. If no | |
| | value is entered, 40 hours will be assumed. | |
| Street Address | Participant's home house number and street name. Include | 12 Main |
| | apartment number. | Street |
| City | Participant's city. | Chicago |
| State | Participant's state. | IL |
| Zip Code | Participant's zip code. | 12345 |
| Date of Hire | The date the participant was hired full time. Enter as | 01/01/1995 |
| | MM/DD/YYYY. | |
| Occupation | Participant's job title or description of their occupation. | Manager |
| Location | Participant's geographical location. | Chicago |
| Phone Number | Participant's home telephone number. | 555-123-1234 |
| Job Code | Numeric code to differentiate participant categories when | 1 |
| | benefits are based on job class, location, etc. | |
| Pay Mode | Pay period frequency. M = Monthly, T = Twice Monthly, B = | B |
| | Bi-Weekly, and W = Weekly. | |
| PA Nicotine Use | Participant's nicotine use. Enter “N” for Non-smoker or “S” for | N |
| | Smoker (includes all tobacco use). | |
| Group Term Life | Group term life insurance provided to the participant, if any. Do | 25000 |
| Amount | not include dollar sign or commas. | |
| STD Benefit | Short term disability insurance provided to the participant, if | 300 |
| Amount | any. Do not include dollar sing or commas. | |
| LTD Benefit | Long term disability insurance provided to the participant, if | 1200 |
| Amount | any. Do not include dollar sign or commas. | |
| SP First Name | Spouse's first name. If there is a middle name, enter first name, | Jane S |
| | space, and middle name. | |
| SP Last Name | Spouse's last name. If there is a suffix or a surname, enter last | Doe |
| | name, space, and suffix or surname. | |
| SP DOB | Spouse's date of birth. Enter as MM/DD/YYYY. | 05/06/1975 |
| SP Nicotine Use | Spouse's nicotine use. Enter “N” for Non-smoker or “S” for | N |
| | Smoker (includes all tobacco use). | |
| DE First Name | Each Dependent's first name. If there is a middle name, enter | John Alan |
| | first name, space, and middle name. | |
| DE Last Name | Each Dependent's last name. If there is a suffix or a surname, | Doe II |
| | enter last name, space, and suffix or surname. | |
| DE DOB | Each Dependent's date of birth. Enter as MM/DD/YYYY. | 03/04/1992 |

In some embodiments, a participant can provide benefit plan information and/or participant information to the benefit enrollment tool 10 in place of or in addition to benefit plan information and/or participant information provided by the plan sponsor. For example, the benefit enrollment tool 10 can operate without interaction with a plan sponsor and can obtain required data from a participant directly. In some embodiments, information provided by the plan sponsor can include information provided by a third-party system, such as a payroll processing system.

In some embodiments, a plan sponsor and/or a participant can provide benefit plan information to the benefit enrollment tool 10 in a file, such as a spreadsheet. A plan provider, who operates or executes the benefit enrollment tool 10, can provide a form or template to the plan sponsor and/or the participant. The form can indicate required and optional data. The plan sponsor and/or the participant can enter the requested data and can provide a completed form to plan provider. In some embodiments, the plan sponsor and/or the participant can send the completed form to the plan provider electronically over a network, such as a LAN or the Internet. In other embodiments, the plan sponsor and/or the participant can store the completed form to memory device, such as a disk and can provide the disk to the plan provider. In still other embodiments, the plan sponsor and/or the participant can provide a hard copy (e.g., a paper copy) of benefit plan information and/or participant information to the plan provider.

In one embodiment, when the plan provider obtains the benefit plan information and the participant information from the plan sponsor and/or the participant, the plan provider can store the benefit plan information and the participant information to the memory module 14. As described above with respect to FIG. 1, the benefit enrollment tool 10 can be located on a personal computer. In some embodiments, the personal computer can include a personal computer of a representative of the plan provider. The representative of the plan provider (“representative”) can then meet with the one or more participants and use the personal computer to operate or execute the benefit enrollment tool 10 and enroll the one or more participants in one or more benefit plans. In some embodiments, the information can be stored in the memory module 14 included in a personal computer of the plan sponsor or the participant and the plan sponsor and/or the participant can use the personal computer to enroll in one or more benefit plans with or without the aid of the representative.

In some embodiments, the benefit plan information and/or the participant information can also be stored in the memory module 14 and the memory module 14 can be located on a server. The representative and/or the participant can access the information stored in the memory module 14 with a workstation over a network, such as a LAN or the Internet.

In some embodiments, after the plan provider obtains the benefit plan information and the participant information, the representative can meet with the participant (step 24). The representative can perform an introductory group meeting with the one or more participants. During the introductory group meeting, the representative can discuss needs met by benefit plans offered by the plan sponsor and can extend an invitation to the one or more participants to sign up for an individualized meeting with the representative. In some embodiments, the introductory group meeting and the individualized meetings can be held on a premise of the plan sponsor.

During an individualized meeting, the representative can operate the benefit enrollment tool 10 to enroll a participant in one or more benefit plans. As described above with respect to FIG. 1, the data and instructions for operating the benefit enrollment tool can be stored in the memory module 14. The memory module 14 can be included in personal computer of the representative, the plan sponsor, or the participant or can be included in server, which can be accessed by a client computer of the representative, the plan sponsor, and/or the participant.

As a preliminary step of operating the benefit enrollment tool 10, the representative can obtain the benefit plan information and the participant information for a particular participant. In some embodiments, the participant can provide a participant identifier, such as a name, a Social Security number, or another unique identifier. Using the participant identifier, the benefit enrollment tool 10 can obtain benefit plan information and participant plan information from the memory module 14. As described above, the memory module 14 can be included in a personal computer of the representative, the plan sponsor, or the participant. In other embodiments, the memory module 14 can be included in a server.

After obtaining the benefit plan information and the participant information, the participant can review the benefit plan information and/or the participant information (step 26). Reviewing the participant information can include making sure that the participant's name, address, date of birth, etc. is correct and that any relationship information (i.e., information about a spouse and/or one or more dependents of the participant) is correct (step 28). If the participant indicates that the participant information is incorrect, the participant can provide modified participant information (step 30).

In some embodiments, reviewing the benefit plan information can include making sure that the current sponsor-provided benefits are correct. If the participant indicates that the benefit plan information is incorrect, the participant can provide modified benefit plan information. In some embodiments, the plan sponsor can provide modified benefit plan information in addition to or in place of modified benefit plan information provided by the participant.

After reviewing the participant information and/or the benefit plan information, the participant can provide additional benefit plan information (step 32). The additional benefit plan information can include information about any additional insurance coverage the participant has purchased on his or her own or has available through a plan sponsor of the participant's spouse. For example, the additional benefit plan information can include information about life insurance, disability insurance, and/or dental insurance held by the participant that covers the participant, his or her spouse, and his or her dependents.

Next, the participant can review the benefit plans offered by the plan provider, such as one or more voluntary benefit plans. Part of the review process can include displaying statistical information about a particular benefit plan (step 34), such as current trends, costs, needs, etc. For example, the benefit enrollment tool 10 can display a percentage of individuals having adequate life insurance, a percentage of individuals having inadequate or no life insurance, odds or risks for being involved in particular life-changing events (e.g., a car accident, a disabling accident, a fire, etc.), a percentage of individuals visiting a dentist in the past year with dental insurance and without dental insurance, current costs of dental procedures, an amount of hours lost to dental-related problems, and other statistical information that can help a participant determine their need for a particular benefit plan. In some embodiments, the statistical information can be stored in the memory module 14. In other embodiments, the statistical information can be obtained from an external source through the input/output module 16. For example, the input/output module 16 can access one or more external sources in order to obtain current statistical information for a particular benefit plan. In some embodiments, the statistical information can include information specific to a particular geographic location, such as the geographic location of the plan sponsor and/or the participant.

For each benefit plan offered by the plan sponsor, the participant can provide benefit plan need information (step 36). The benefit plan need information can include information about insurance and/or financial expenses and needs of the participant that a particular benefit plan can help meet. For example, the benefit plan need information can include information about expenses to be covered by a life insurance plan (e.g., funeral expenses, car loans, credit card debt, college education for one or more dependents, extra income, etc.), expenses to be covered by a disability insurance plan (e.g., mortgage/rent, utilities, car payments, credit card debt, childcare, food, insurance, etc.), and expenses to be covered by a dental insurance plan. In some embodiments, the benefit plan need information can include information about existing insurance or other financial products that can help meet insurance and/or financial expenses and needs. For example, the benefit plan need information can include any insurance policies, additional sources of income, and/or other assets owned by the participant.

In some embodiments, the benefit enrollment tool 10 can use the benefit plan need information to determine a remaining need for a particular benefit plan. For example, the benefit enrollment tool 10 can total the expenses or needs to be covered by a particular benefit plan and can subtract any existing insurance or other financial products that can help meet the expenses or needs in order to determine a remaining need. In some embodiments, the benefit enrollment tool 10 can generate a graphical representation of a remaining need or gap for a particular benefit plan.

After obtaining the benefit plan need information, the participant can provide needs priority information (step 40). The needs priority information can include information that prioritizes particular needs of the participant. For example, the participant can prioritize or rank a need to provide benefits in the event of the death of the participant, the participant's spouse, or a dependent of the participant; a need to provide income if the participant cannot work because of a short term disability; a need to provide income if the participant cannot work because of a long term disability, and a need to provide benefits to cover dental care expenses as well as protecting the dental health of the participant, the participant's spouse, and/or one or more dependents of the participant. In some embodiments, the participant can rank the needs from 1 to the number of listed needs, with 1 being assigned to the need that is most important to the participant.

The benefit enrollment tool 10 can use the benefit plan information, the participant information, the additional benefit plan information, the benefit plan need information, and/or the needs priority information to determine benefit plan suggestion information (step 42). The benefit plan suggestion information can include one or more suggested benefit plans and/or one or more suggested options (e.g., benefit amounts, benefit coverage, benefit costs, etc.) for the one or more benefit plans. For example, the benefit plan suggestion information can include information about a minimum benefit amount, a guarantee, issue amount, and a maximum benefit amount for a group voluntary term life insurance policy for the participant. In some embodiments, the benefit plan suggestion information can include information about a cost, such as a cost per pay period for a particular benefit plan and/or benefit plan options. The benefit plan suggestion information can include information about whether the participant, the participant's spouse, and/or one or more dependents of the participants would be covered by a particular benefit plan, such as a dental insurance plan. In some embodiments, the benefit plan suggestion information can include information about a remaining need or gap for a particular benefit plan as described above (step 36).

Using the benefit plan suggestion information, the participant can review the benefit plan suggestion information (step 44) and can provide one or more benefit plan selections (step 46). In some embodiments, the participant can modify the benefit plan suggestion information in order to indicate the one or more benefit plan selections. For example, the participant can change a benefit amount, benefit coverage, and/or other benefit options included in the benefit plan suggestion information. Once the participant has modified the benefit plan suggestion information as desired, the participant can submit the modified benefit plan suggestion information as the one or more benefit plan selections.

In some embodiments, after the participant provides the one or more benefit plan selections, the benefit enrollment tool 10 can provide a benefit plan summary to the participant (step 48). The benefit plan summary can include the one or more benefit plan selections. For example, the benefit plan summary can include the one or more benefit plan selections, such as a group voluntary term life insurance plan selection, a group short term disability insurance plan selection, a group long term disability insurance plan selection, and a group dental insurance plan selection. In some embodiments, each benefit plan selection can indicate benefit coverage (e.g., participant-only coverage, participant and spouse coverage, or participant, spouse, and dependent coverage), benefit amount, and a cost per pay period. The benefit plan summary can also include a total cost per pay period, which can include the cost per pay period for each benefit plan selected by the participant. In some embodiments, the benefit plan summary can include a future planning section where the participant, the representative, and/or the plan sponsor can indicate instructions for modifying benefit plan selections in the future. The benefit plan summary can include a savings indication. In some embodiments, the savings indication can indicate an estimated savings (e.g., tax savings) per pay period by enrolling in one or more benefit plans as specified by the one or more benefit selections. In some embodiments, the savings indication only indicates estimated savings for benefit plans eligible for a Section 125 premium only plan (i.e., plans that allows the premiums to be paid with before-tax dollars).

After the participant provides the one or more benefit plan selections, the benefit enrollment tool 10 can enroll the participant in one or more benefit plans based on the one or more benefit plan selections (step 50). In some embodiments, the benefit enrollment tool 10 can interface with an administration system, as described below with respect to FIG. 17, in order to enroll the participant in one or more benefit plans. The administration system can record the one or more benefit plan selections, indicate that the participant is eligible for a particular benefit, and/or bill the participant for benefit costs. In other embodiments, the benefit enrollment tool 10 can generate a hard copy of the benefit plan summary, which the participant can use to enroll in the selected benefits.

In some embodiments, the enrollment process provided through the benefit enrollment tool 10 as described above with respect to FIGS. 2A and 2B can be performed to re-enroll a participant in one or more benefit plans.

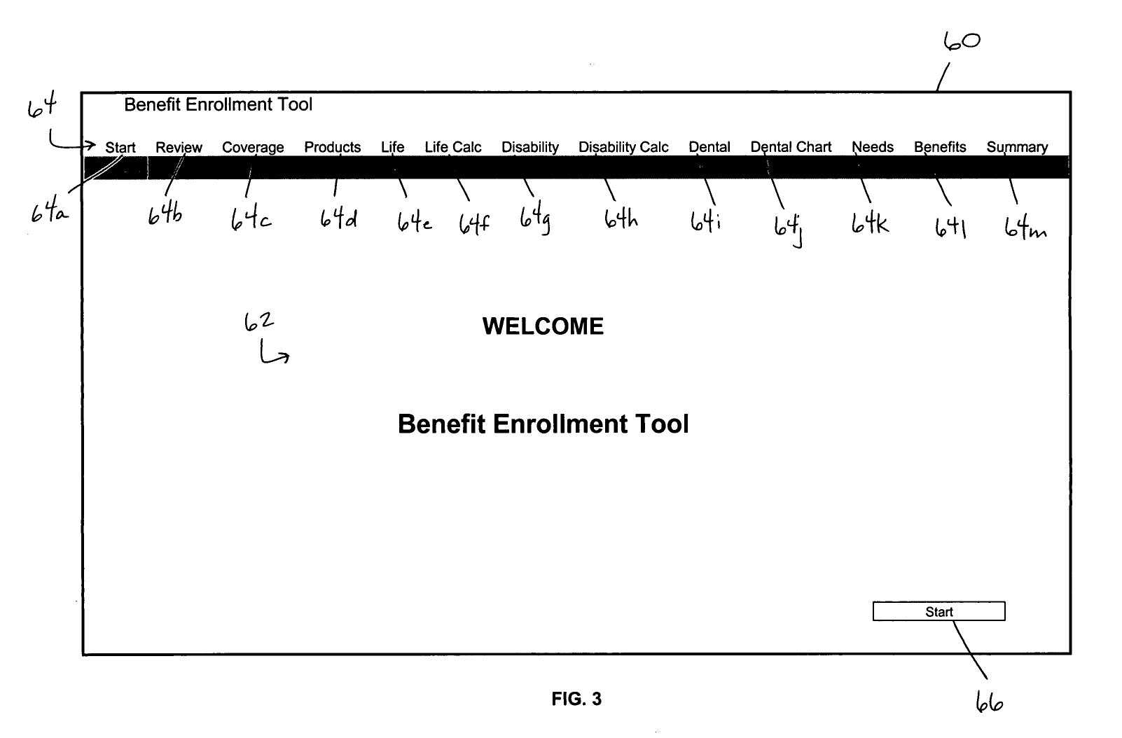

FIGS. 3-15 illustrate user interface screens generated with the benefit enrollment tool 10 according to one embodiment of the invention. The benefit enrollment tool 10 can display the user interfaces to the participant in order to assist the participant in enrolling in one or more benefit plans.

FIG. 3 illustrates a welcome screen 60 according to one embodiment of the invention. In some embodiments, the welcome screen 60 can be a first screen displayed to the participant when operating the benefit enrollment tool 10. As shown in FIG. 3, the welcome screen 60 can include a welcome message 62, a menu bar 64, and a start selector (e.g., a button) 66. The welcome message 62 can welcome the participant, the representative, and/or the plan sponsor to the benefit enrollment tool 10 and can provide instructions for using the benefit enrollment tool 10.

As shown in FIG. 3, the menu bar 64 can include links to screens provided by the benefit enrollment tool 10. For example, the menu bar 64 can include a start link 64a, a review link 64b, a coverage link 64c, a products link 64d, a life insurance (“Life”) link 64e, a life insurance calculation (“Life Calc”) link 64f, a disability insurance (“Disability”) link 64g, a disability insurance calculation (“Disability Calc”) link 64h, a dental insurance (“Dental”) link 64i, a dental insurance chart (“Dental Chart”) link 64j, a needs link 64k, a benefits link 64l, and a summary link 64m. Selecting a link (e.g., clicking on a link) can access or display a particular screen displayed by the benefit enrollment tool 10. For example, selecting the start link 64a can display the welcome screen 60.

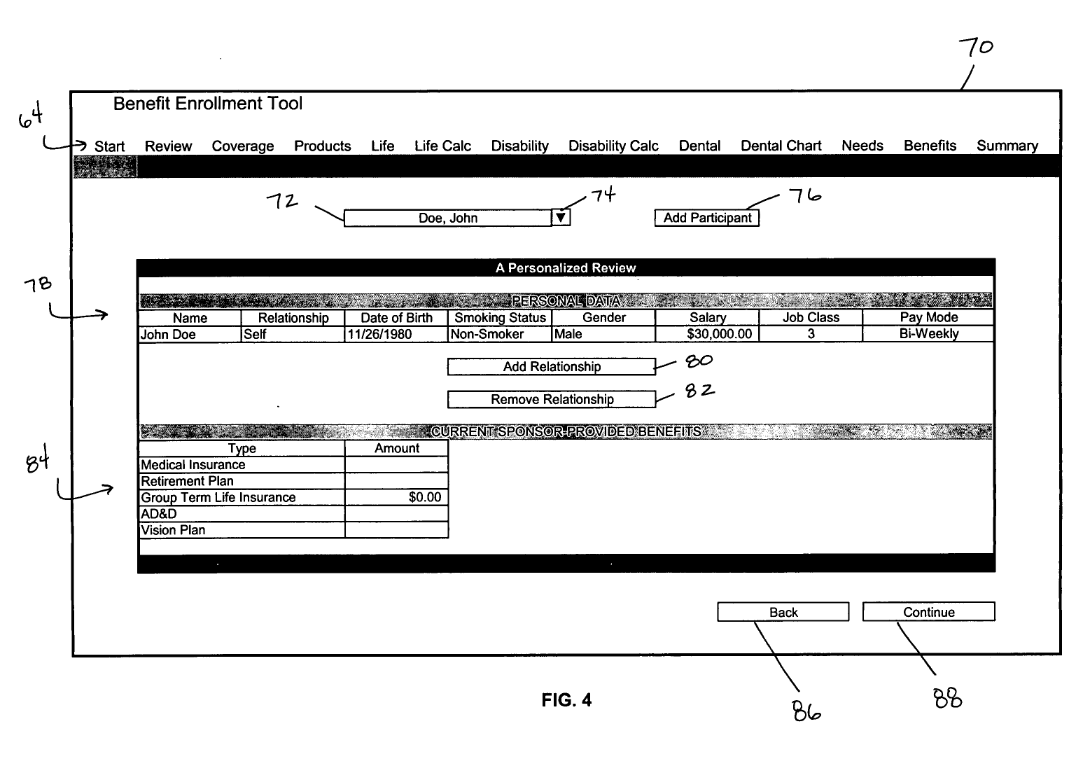

Selecting the start selector 66 included in the welcome screen 60 can display a next screen to be displayed by the benefit enrollment tool 10, such as a review screen. FIG. 4 illustrates a review screen 70 according to one embodiment of the invention. In some embodiments, selecting the review link 64b can also display the review screen 70. As shown in FIG. 4, the review screen 70 can include the menu bar 64, a participant identifier 72, a participant selector 74, an add employee selector 76, a participant information section 78, an add relationship selector 80, a remove relationship selector 82, a current sponsor-provided benefits section 84, a back selector 86, and a continue selector 88.

The participant identifier 72 can indicate a currently-selected participant for whom information is displayed on the review screen 70. A participant can be identified by a name, a Social Security number, or another identifier. In some embodiments, the participant, recipient, and/or plan sponsor (hereinafter the “user”) can use the participant selector 74 to select a particular participant. For example, the participant selector 74 can include a drop-down arrow that the user can select (e.g., click on) to obtain a list of available participants. To view information associated with a particular participant, the user can select the participant from the list of available participants. If the list of available participants does not include a particular participant, the user can select the add employee selector 76. Selecting the add employee selector 76 can display one or more screens where the user can add a new participant and related benefit plan information and/or participant information.

As shown in FIG. 4, the participant information section 78 can display information about a selected participant as indicated by the participant identifier 72. The information displayed in the participant information section 78 can include a participant's name, a participant's relationship (e.g., self, spouse, or dependent), a participant's date of birth, a participant's smoking status, a participant's gender, a participant's salary, a participant's job class, and a participant's pay mode. In some embodiments, information about a participant's spouse and/or dependents can also be displayed in the participant information section 78 and can be added and removed using the add relationship selector 80 and the remove relationship selector 82 respectively.

The current sponsor-provided benefits section 84 can display benefit plans currently offered to a participant by a plan sponsor. In some embodiments, the current sponsor-provided benefits section 84 can also display benefit amounts associated with available benefit plans.

In some embodiments, the review screen 70 can include mechanisms for modifying the participant information displayed in the participant information section 78 and/or the benefit information displayed in the current sponsor-provided benefits section 84.

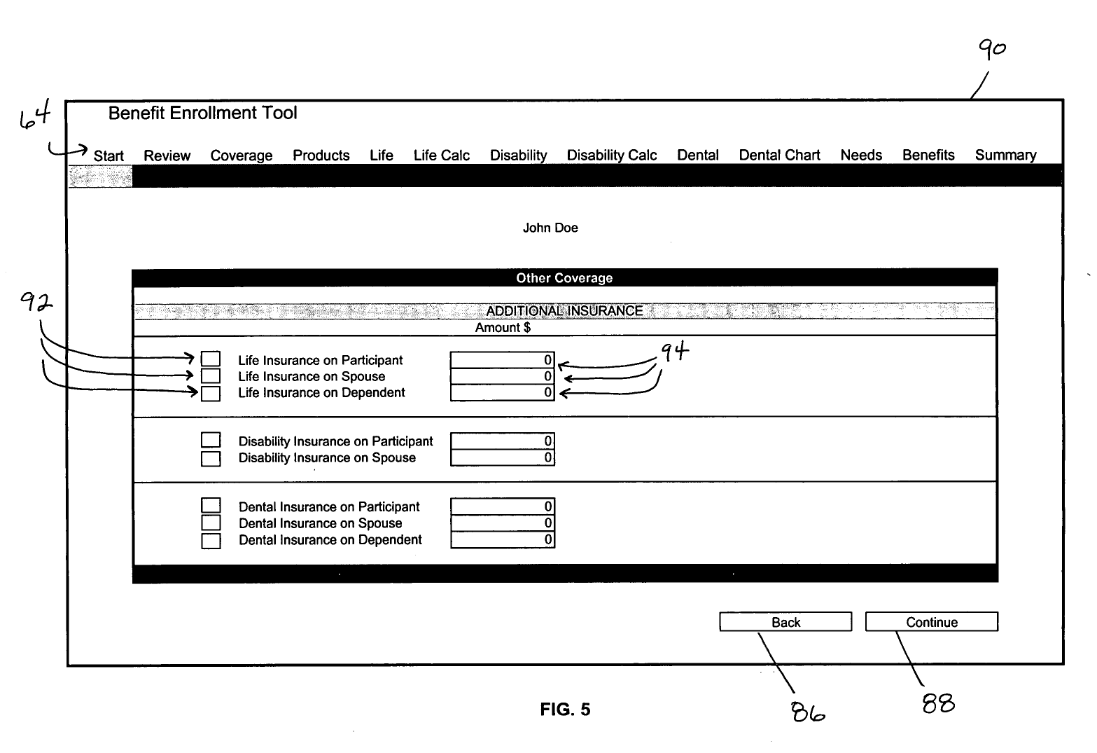

Selecting the back selector 86 on the review screen 70 can display a previously-displayed screen, such as the welcome screen 60. Selecting the continue selector 88 on the review screen 70 can display a next screen to be displayed by the benefit enrollment tool 10, such as a coverage screen. FIG. 5 illustrates a coverage screen 90 according to one embodiment of the invention. In some embodiments, selecting the coverage link 64c can also display the coverage screen 90. As shown in FIG. 5, the coverage screen 90 can include the menu bar 64, one or more coverage selectors 92, one or more coverage amount fields 94, the back selector 86, and the continue selector 88. In some embodiments, the user can use the coverage selectors 92 to indicate one or more insurance and/or financial products held by a participant. For example, the user can select a coverage selector 92 to indicate that a participant holds a life insurance plan, a disability insurance plan, and/or a dental plan for himself or herself, their spouse, and/or their dependents. The user can use the coverage amount fields 94 to indicate benefit amounts associated with each selected insurance and/or financial product.

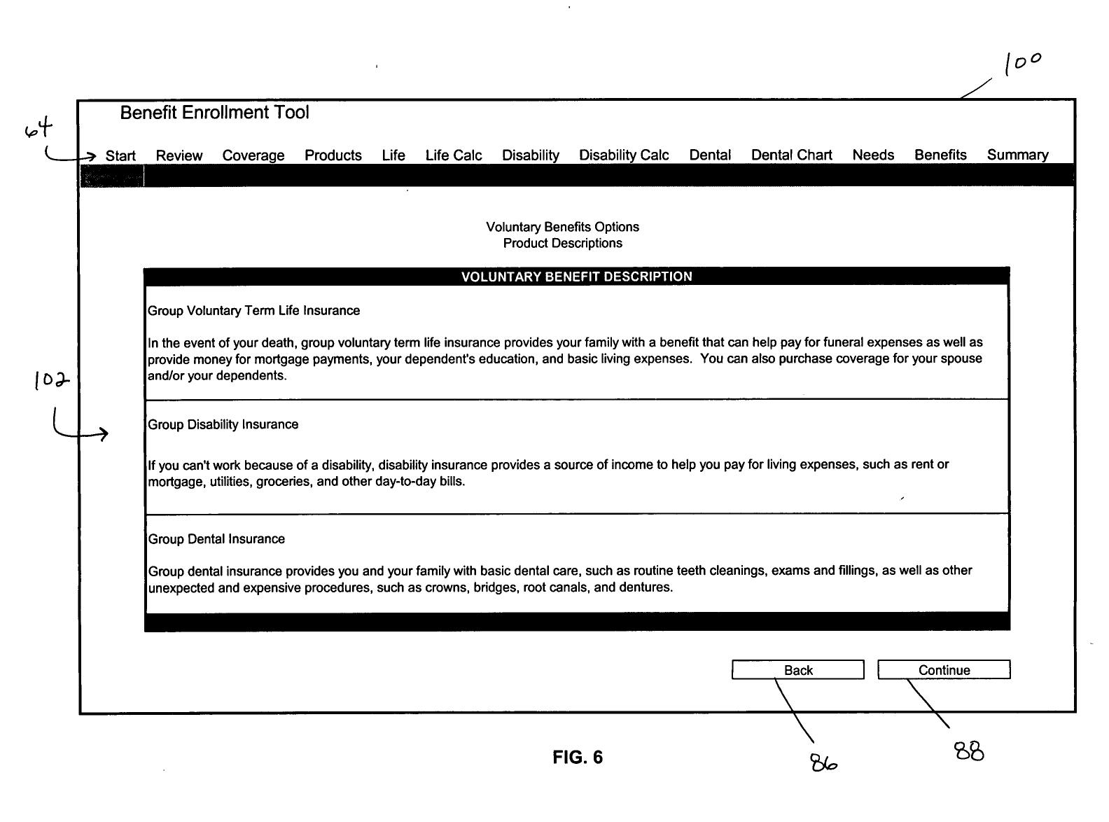

Selecting the back selector 86 on the coverage screen 90 can display a previously-displayed screen, such as the review screen 60. Selecting the continue selector 88 on the coverage screen 90 can display a next screen to be displayed by the benefit enrollment tool 10, such as a products screen. FIG. 6 illustrates a products screen 100 according to one embodiment of the invention. In some embodiments, selecting the products link 64d can also display the products screen 100. As shown in FIG. 6, the products screen 100 can include the menu bar 64, a products description section 102, the back selector 86, and the continue selector 86. The products description section 102 can display information about one or more benefit plans, such as voluntary benefits available for a participant to enroll in.

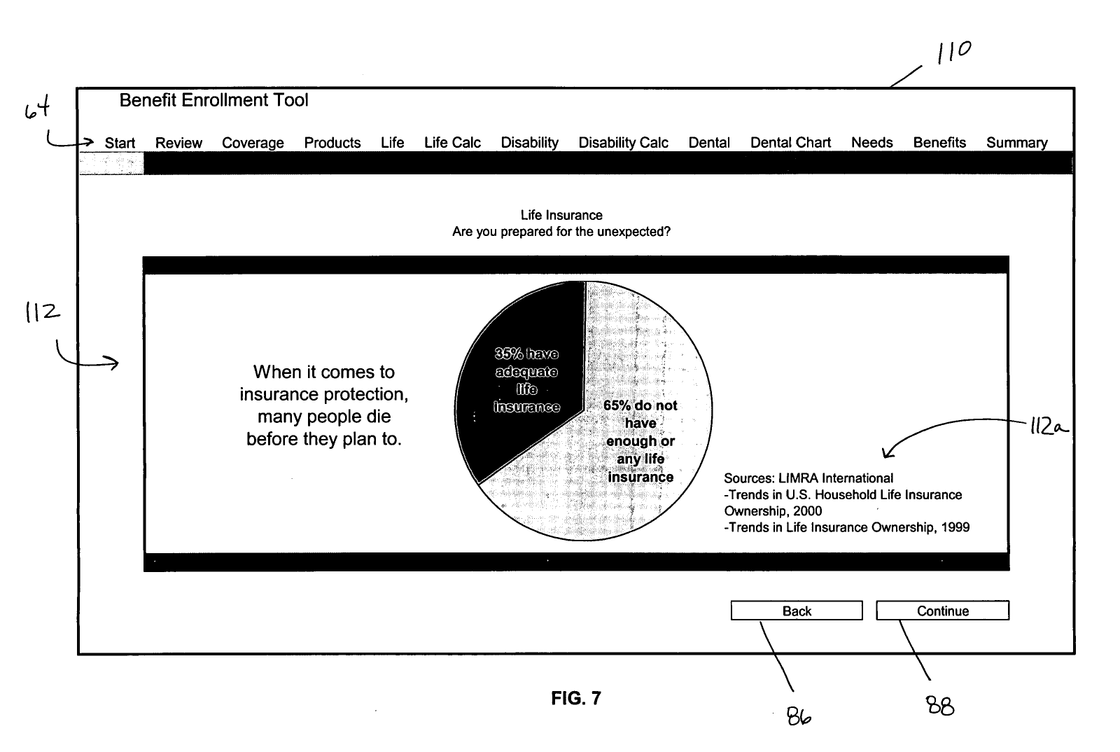

Selecting the back selector 86 on the products screen 100 can display a previously-displayed screen, such as the coverage screen 90. Selecting the continue selector 88 on the products screen 100 can display a next screen to be displayed by the benefit enrollment tool 10, such as a life insurance screen. FIG. 7 illustrates a life insurance screen 110 according to one embodiment of the invention. In some embodiments, selecting the life insurance link 64e can also display the life insurance screen 110. As shown in FIG. 7, the life insurance screen 110 can include the menu bar 64, a statistical information section 112, the back selector 86, and the continue selector 88. The statistical information section 112 can display statistical information about life insurance. For example, the statistical information section 112 can display a percentage of individuals that have adequate life insurance and a percentage of individuals that do not have adequate or any life insurance. In some embodiments, the statistical information section 112 can include source section 112a that indicates one or more sources of statistical information displayed in the statistical information section 112.

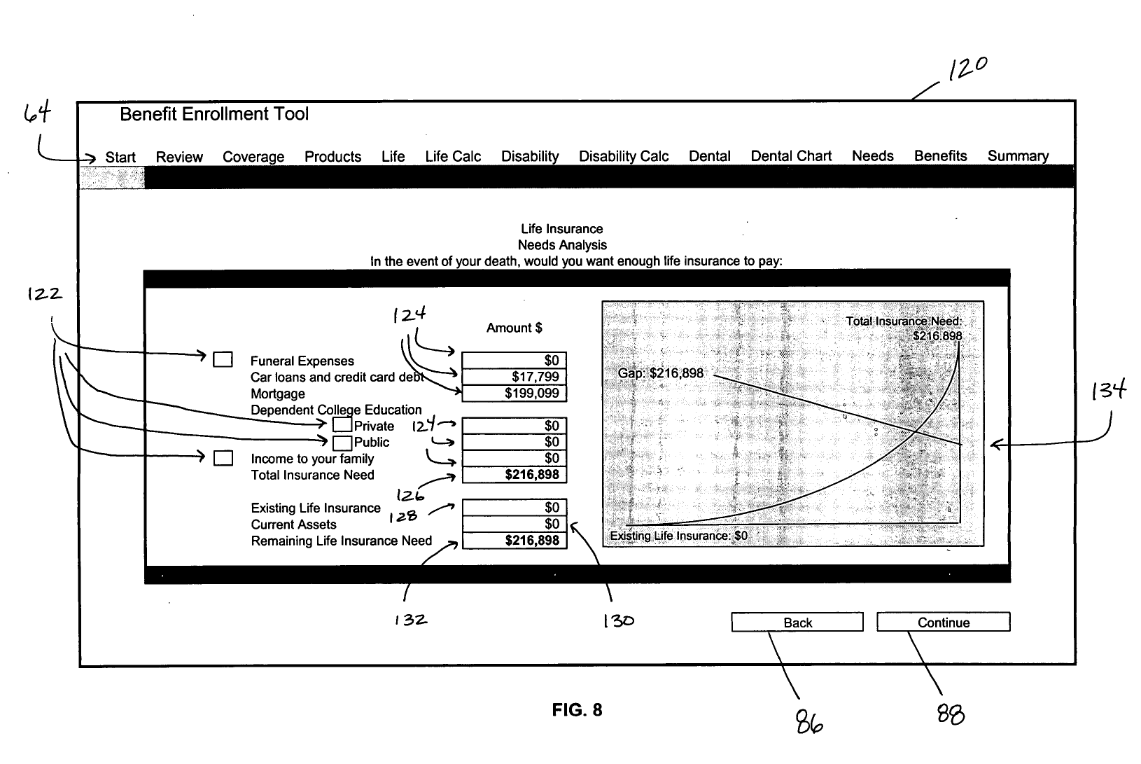

Selecting the back selector 86 on the life insurance screen 110 can display a previously-displayed screen, such as the products screen 100. Selecting the continue selector 88 on the life insurance screen 110 can display a next screen to be displayed by the benefit enrollment system 10, such as a life insurance calculation screen. FIG. 8 illustrates a life insurance calculation screen 120 according to one embodiment of the invention. In some embodiments, selecting the life insurance calculation link 64f can also display the life insurance calculation screen 120. As shown in FIG. 8, the life insurance calculation screen 120 can include the menu bar 64, one or more expense selectors 122, one or more expense amount fields 124, a total insurance need field 126, an existing life insurance field 128, a current assets field 130, a remaining need field 132, a need graphical representation 134, the back selector 86, and the continue selector 88. The user can select the expense selectors 122 to indicate an expense that the participant desires to pay for with a life insurance plan, and the user can enter a corresponding expense amount in one of the expense amount fields 124. The total insurance need field 126 can display the total of the expense amounts entered in the expense amount fields 124.

The user can enter an existing life insurance amount held by a participant in the existing life insurance field 128. In some embodiments, the existing life insurance field 128 can display an existing life insurance amount as entered on the coverage screen 90 (see FIG. 5). The user can also enter an amount of current assets of a participant in the current assets field 130. The remaining need field 132 can display the total of the existing life insurance amount (i.e., the amount displayed in the existing life insurance field 128) and the amount of current assets (i.e., the amount displayed in the current assets field 130) subtracted from the total of the expense amounts entered in the expense amount fields 124 (i.e., the amount displayed in the total insurance need field 126). The amount displayed in the remaining need field 132 can represent an amount of life insurance needed to pay for selected expenses. In some embodiments, the need graphical representation 134 can graphically indicate a remaining need or gap between coverage already held by a participant and coverage needed by the participant to cover selected expenses (i.e., the amount displayed in the remaining need field 132).

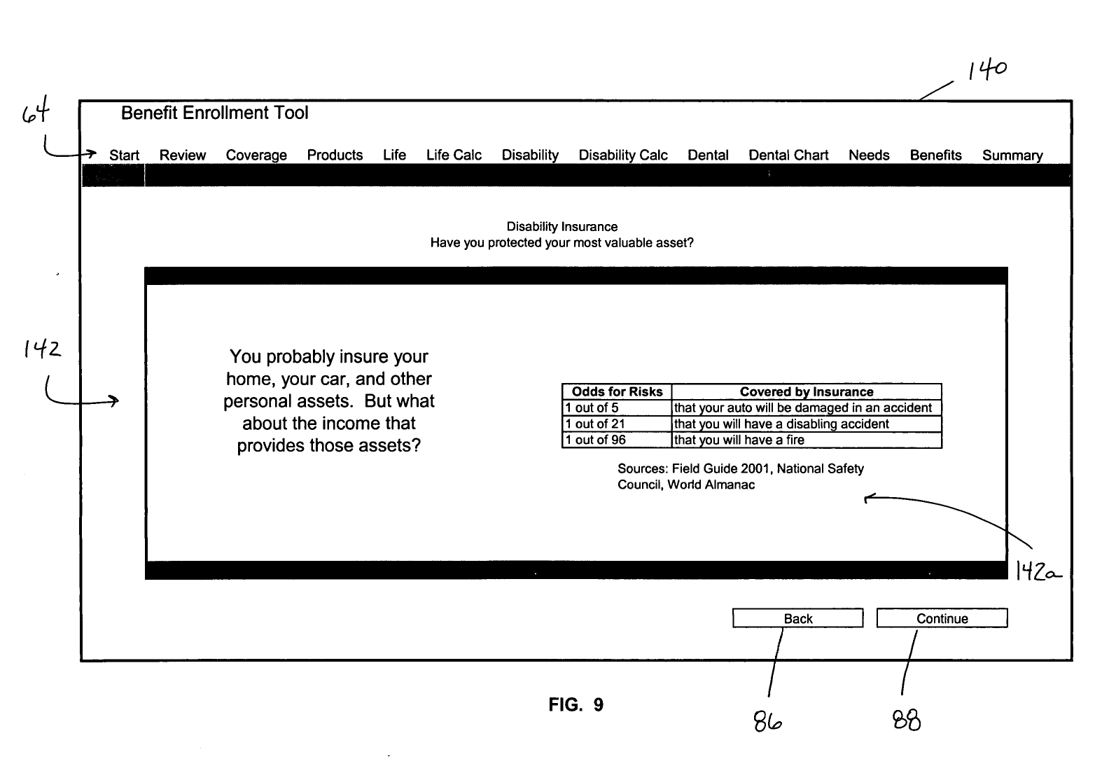

Selecting the back selector 86 on the life insurance calculation screen 120 can display a previously-displayed screen, such as the life insurance screen 110. Selecting the continue selector 88 on the life insurance calculation screen 120 can display a next screen to be displayed by the benefit enrollment tool 10, such as a disability insurance screen. FIG. 9 illustrates a disability insurance screen 140 according to one embodiment of the invention. In some embodiments, selecting the disability link 64g can also display the disability insurance screen 140. As shown in FIG. 9, the disability insurance screen 140 can include the menu bar 64, a statistical information section 142, the back selector 86, and the continue selector 88. The statistical information section 142 can display statistical information about disability insurance. For example, the statistical information section 142 can display odds for being involved in a car accident, odds for being involved in a disabling event, and odds for having a fire. In some embodiments, the statistical information section 142 can include source section 142a that indicates one or more sources of the statistical information displayed in the statistical information section 142.

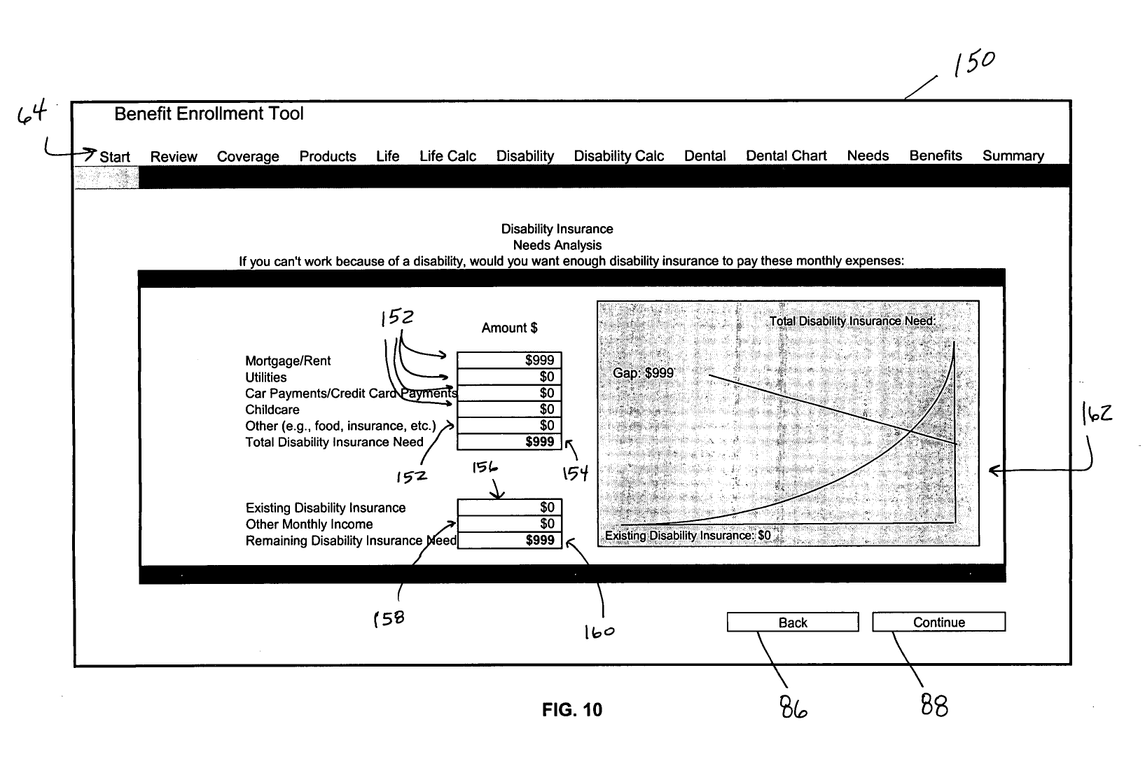

Selecting the back selector 86 on the disability insurance screen 140 can display a previously-displayed screen, such as the life insurance calculation screen 120. Selecting the continue selector 88 on the disability insurance screen 140 can display a next screen to be displayed by the benefit enrollment tool 10, such as a disability insurance calculation screen. FIG. 10 illustrates a disability insurance calculation screen 150 according to one embodiment of the invention. In some embodiments, selecting the disability insurance calculation link 64h can also display the disability insurance calculation screen 150. As shown in FIG. 10, the disability insurance calculation screen 150 can include the menu bar 64, one or more expense amount fields 152, a total insurance need field 154, an existing disability insurance field 156, an other income field 158, a remaining need field 160, a need graphical representation 162, the back selector 86, and the continue selector 88. The user can enter an expense amount in one of the expense amount fields 152 to indicate an amount of an expense to be covered by a disability insurance plan, such as a mortgage, a rent, utilities, car payments, credit card payments, childcare, food, insurance, etc. The total insurance need field 154 can display the total of the expense amounts entered in the expense amount fields 152.

The user can enter an existing disability insurance amount held by a participant in the existing disability insurance field 156. In some embodiments, the existing disability insurance field 156 can display an existing disability insurance amount as entered on the coverage screen 90 (see FIG. 5). The user can enter an amount of income received by the participant from other sources in the other income field 158. The remaining need field 160 can display the total of the existing disability insurance amount (i.e., the amount displayed in the existing disability insurance field 156) and the amount of income received from other sources (i.e., the amount displayed in the other income field 158) subtracted from the total of the expense amounts entered in the expense amount fields 152 (i.e., the amount displayed in the total insurance need field 154). The amount displayed in the remaining need field 160 can represent an amount of disability insurance needed to pay for selected expenses. In some embodiments, the need graphical representation 160 can graphically indicate a remaining need or gap between coverage already held by a participant and coverage needed by the participant to cover selected expenses (i.e., the amount displayed in the remaining need field 160).

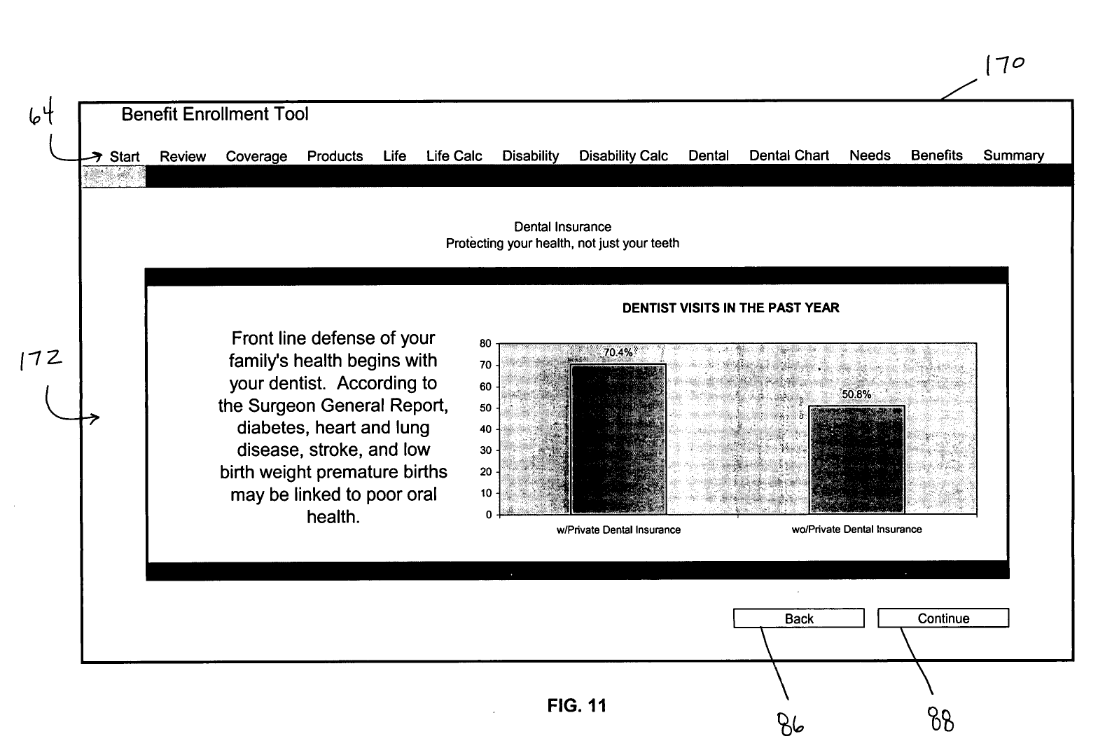

Selecting the back selector 86 on the disability insurance calculation screen 150 can display a previously-displayed screen, such as the disability insurance screen 140. Selecting the continue selector 88 on the disability insurance calculation screen 150 can display a next screen to be displayed by the benefit enrollment tool 10, such as a dental insurance screen. FIG. 11 illustrates a dental insurance screen 170 according to one embodiment of the invention. In some embodiments, selecting the dental insurance link 64i can also display the dental insurance screen 170. As shown in FIG. 11, the dental insurance screen 170 can include the menu bar 64, a statistical information section 172, the back selector 86, and the continue selector 88. The statistical information section 172 can display statistical information about dental insurance. For example, the statistical information section 172 can display a percentage of individuals with dental insurance that visited a dentist in the past year and a percentage of individuals without dental insurance that visited a dentist in the past year. In some embodiments, the statistical information section 172 can include source section (not shown) that indicates one or more sources of the statistical information displayed in the statistical information section 172.

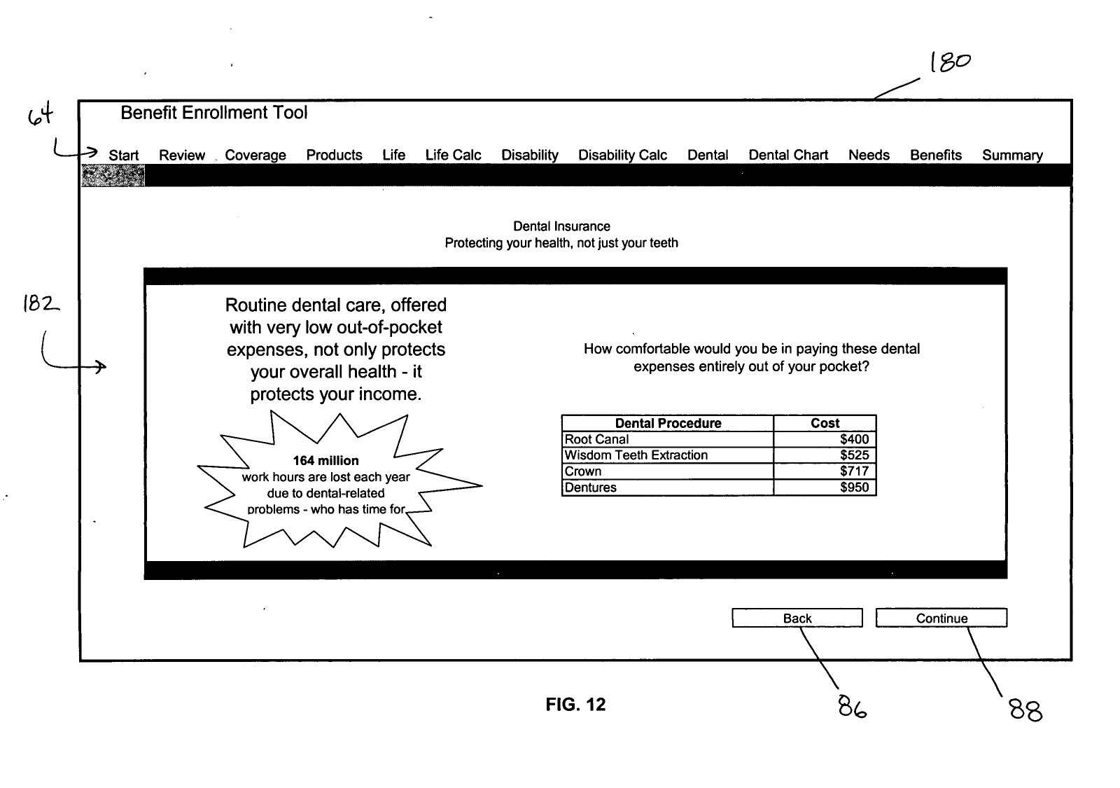

Selecting the back selector 86 on the dental insurance screen 170 can display a previously-displayed screen, such as the disability insurance calculation screen 150. Selecting the continue selector 88 on the dental insurance screen 170 can display a next screen to be displayed by the benefit enrollment tool 10, such as a dental insurance calculation or chart screen. FIG. 12 illustrates a dental insurance chart screen 180 according to one embodiment of the invention. In some embodiments, selecting the dental insurance chart link 64j can also display the dental insurance chart screen 180. As shown in FIG. 12, the dental insurance chart screen 180 can include the menu bar 64, a dental information section 182, the back selector 86, and the continue selector 88. The dental information section 182 can include information about dental insurance, dental procedures, and other dentistry-related information. For example, the dental information section 182 can display information about the cost of dental procedures. In some embodiments, the dental information section 182 can also display additional statistical information, such as a number of work-hours lost due to dental-related problems. In some embodiments, the dental information section 182 can display information about dental procedures (e.g., costs, statistics, etc.) that are specific to a geographic region, such as the geographic region of the plan sponsor and/or the plan provider.

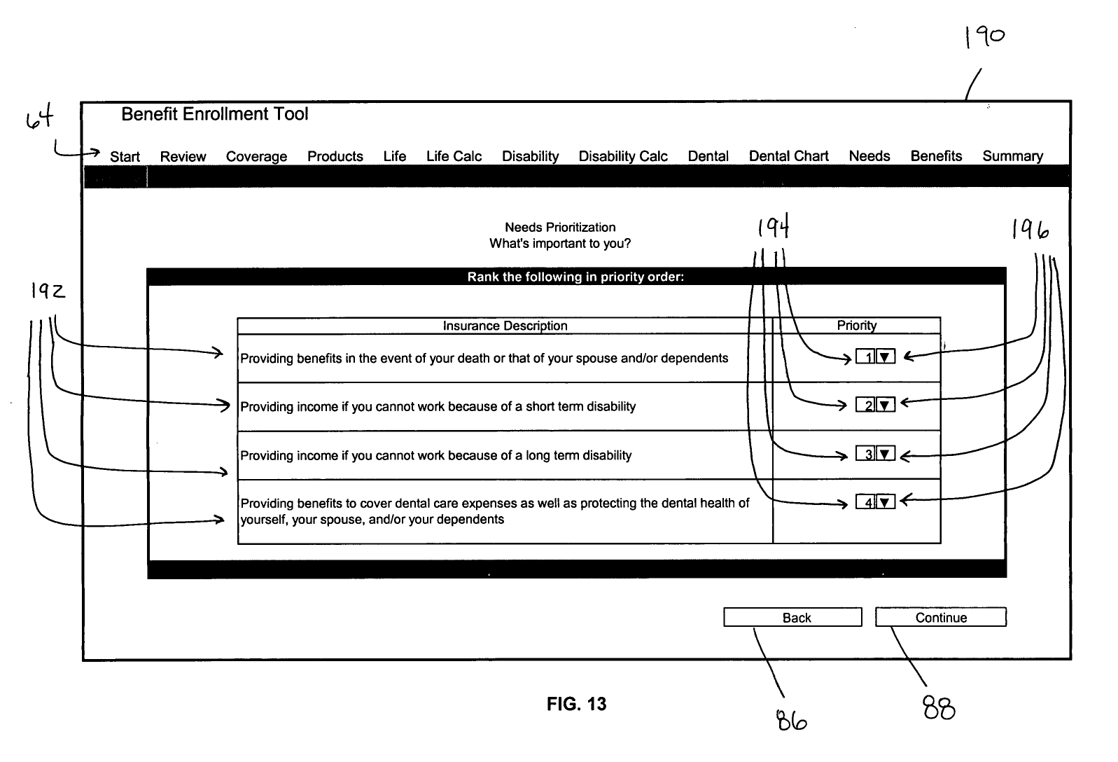

Selecting the back selector 86 on the dental insurance chart screen 180 can display a previously-displayed screen, such as the dental insurance screen 170. Selecting the continue selector 88 on the dental insurance chart screen 180 can display a next screen to be displayed by the benefit enrollment tool 10, such as a needs screen. FIG. 13 illustrates a needs screen 190 according to one embodiment of the invention. In some embodiments, selecting the needs link 64k can also display the needs screen 190. As shown in FIG. 13, the needs screen 190 can include the menu bar 64, need descriptions 192, priority indicators 194, priority selectors 196, the back selector 86, and the continue selector 88. Each need description 192 displays a particular need, such as a need to provide benefits in the event of the death of a participant, a participant's spouse, or dependents of the participant. As shown in FIG. 13, each need description 192 can be associated with a priority indicator 194 and a priority selector 196. The priority indicator 194 can indicate a currently assigned priority to the need displayed in the corresponding need description 192. In some embodiments, the needs listed in the need descriptions 192 can be ranked from 1 to the number of listed needs, where a priority of 1 indicates a most important need to a participant. To change a priority for a particular need; the user can select the corresponding priority selector 196. In some embodiments, the priority selector 196 can include a selection mechanism, such as a drop-down arrow that the user can select (e.g., click on) in order to obtain a list of available priorities and select a priority. In some embodiments, the needs screen 190 can prohibit the user from setting multiple needs to the same priority.

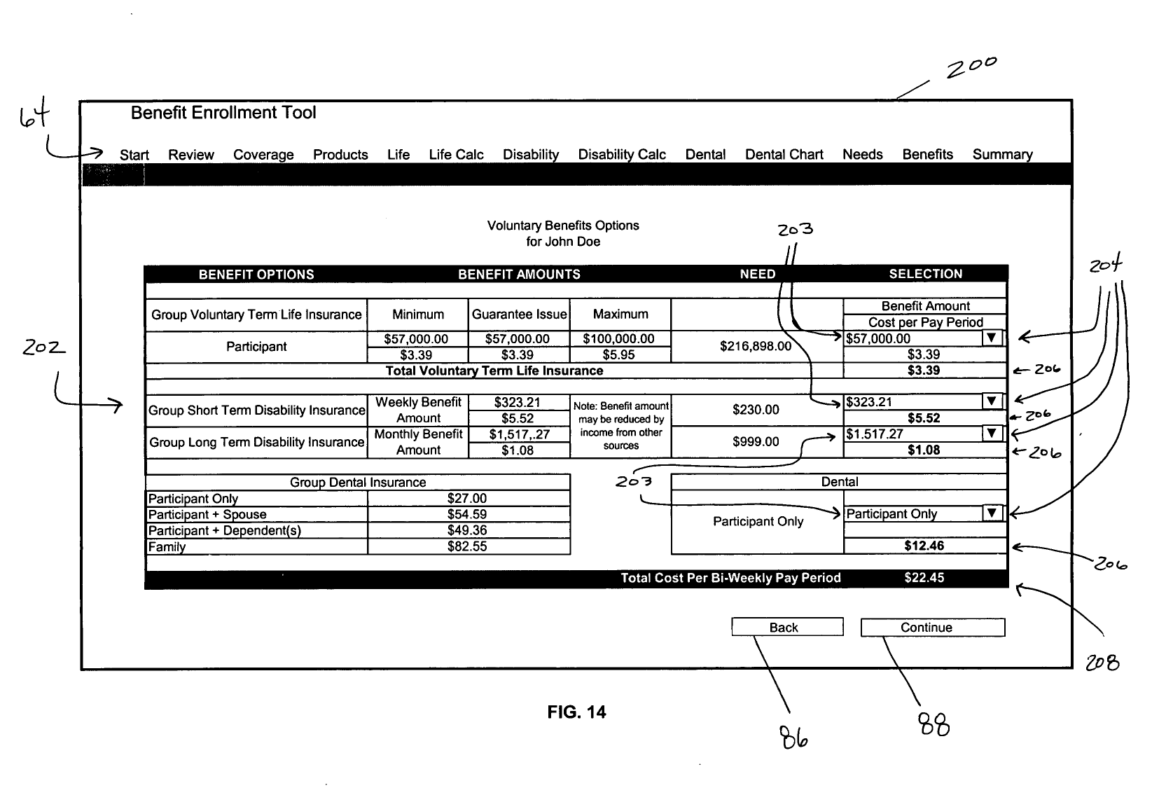

Selecting the back selector 86 on the needs screen 190 can display a previously-displayed screen, such as the dental insurance chart screen 180. Selecting the continue selector 88 on the needs screen 190 can display a next screen to be displayed by the benefit enrollment tool 10, such as a benefit screen. FIG. 14 illustrates a benefits screen 200 according to one embodiment of the invention. In some embodiments, selecting the benefits link 641 can also display the benefit screen 200. As shown in FIG. 14, the benefits screen 200 can include the menu bar 64, a benefit plan suggestion section 202, benefit selection indicators 203, benefit selectors 204, benefit cost sub-total fields 206, a benefit cost total field 208, the back selector 86, and the continue selector 88. The benefit plan suggestion section 202 can display benefit plan suggestion information determined by the benefit enrollment tool 10. As shown in FIG. 14, the benefit plan suggestion section 202 can display one or more benefit plans and, for each benefit plan, can display benefit options, benefit amounts, benefit needs, and benefit costs. The benefit selection indicators 203 can display benefit selections based on the benefit plan suggestion information. Each benefit selection indicator 203 can be associated with a benefit selector 204. The user can modify a benefit selection displayed by a benefit selection indicator 203 by selecting a benefit selector 204 associated with the benefit selection indicator 203. Each benefit selector 204 can be associated with a particular benefit plan. For example, as shown in FIG. 14, a group voluntary term life insurance plan, a group short term disability insurance plan, a group long term disability insurance plan, and a group dental insurance plan can each be associated with a benefit selector 204. In some embodiments, each benefit selector 204 can include a selection mechanism, such as a drop-down arrow, that when selected displays a list of available benefit selections. For example, selecting the benefit selector 204 associated with a group voluntary term life insurance plan can display a list of available benefit amounts that can be selected by the user.

Each benefit plan displayed in the benefit plan suggestion section 202 can be associated with a benefit cost sub-total field 206, which indicates a cost of a benefit selection (e.g., a cost per pay period). As the user modifies a benefit selection displayed in a benefit selection indicator 203 using a benefit selector 204, the cost of a benefit selection displayed in the benefit cost sub-total field 206 can be modified. The benefit cost total field 206 can display a total of benefit costs displayed in each benefit cost sub-total field 206.

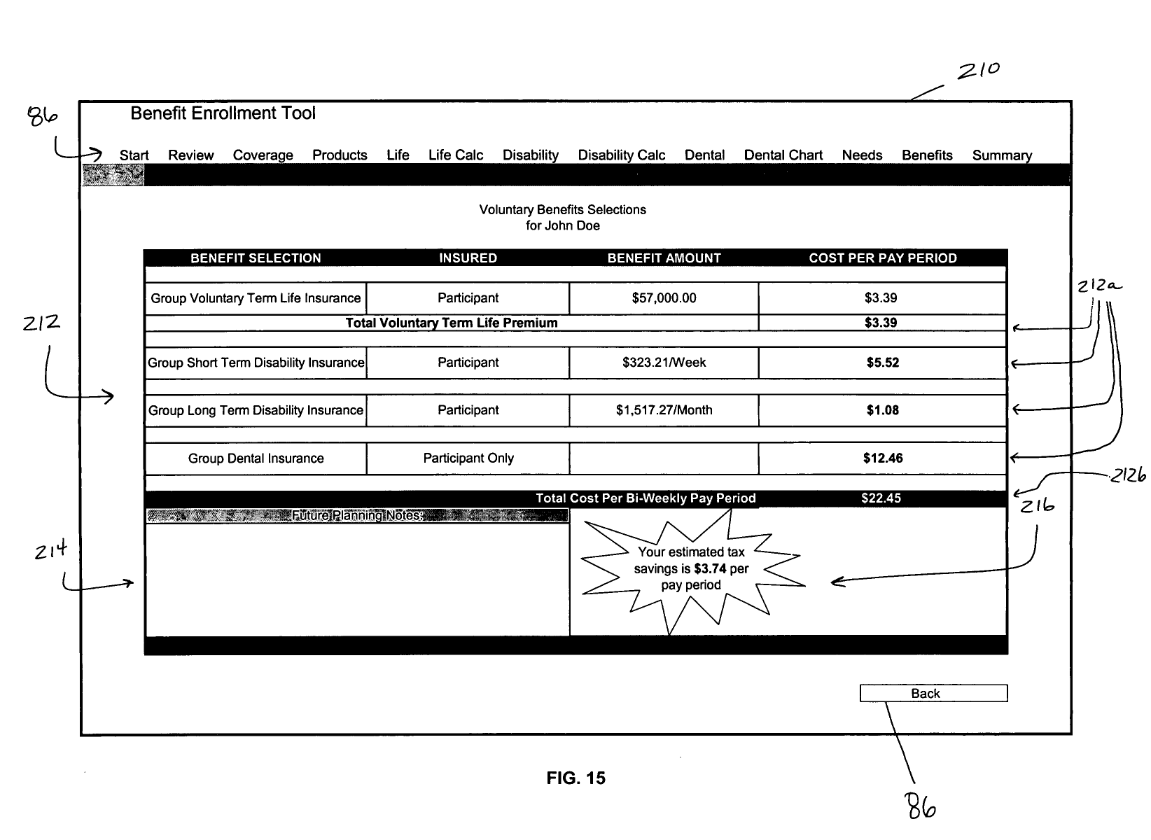

Selecting the back selector 86 on the benefits screen 200 can display a previously-displayed screen, such as the needs screen 190. Selecting the continue selector 88 on the benefits screen 200 can display a next screen to be displayed by the benefit enrollment tool 10, such as a summary screen. FIG. 15 illustrates a summary screen 210 according to one embodiment of the invention. In some embodiments, selecting the summary link 64m can also display the summary screen 210. As shown in FIG. 15, the summary screen 210 can include the menu bar, a benefit plan summary section 212, and the back selector 86. The benefit plan summary section 212 can display a benefit plan summary, which indicates benefit plan selections made by a participant. The benefit plan summary section 212 can display one or more benefit plans and benefit plan selections for each benefit plan. The benefit plan summary section 212 can display benefit plan selections based on the benefit plan selections indicated on the benefits screen 200 when the user selected the continue selector 88 to display the summary screen 210. Each displayed benefit selection can be associated with a corresponding benefit cost field 212a. Each benefit cost field 212a can indicate a cost (e.g., a cost per pay period) for a particular benefit plan given the benefit selections indicated by the user. In some embodiments, the benefit plan summary section 212 can include a total benefit cost field 212b that indicates a total of each benefit cost field 212a.

As shown in FIG. 15, the benefit plan summary section 212 can include a future planning section 214 and an estimated savings section 216. The future planning section 214 can display notes entered by the user as to future benefit needs, benefit offerings, benefit selections, etc. The estimated savings section 216 can display estimated savings based on the benefit selections indicated in the benefit plan summary section 212. In some embodiments, the estimated savings section 216 can display estimated tax savings.

Selecting the back selector 86 on the summary screen 210 can display a previously-displayed screen, such as the benefits screen 200.

In some embodiments, the summary screen 210 can include an enroll selector (not shown) that the user can select in order to enroll in one or more benefit plans based on the benefit selections indicated in the benefit plan summary section 212. For example, the user can click on the enroll selector to transmit benefit selections to an administration system. The administration can record the one or more benefit plan selections, indicate that the participant is eligible for a particular benefit, and/or bill the participant for benefit costs. In other embodiments, the summary screen 210 can include a print selector (not shown) that the user can select in order to print of copy of the benefit plan selections displayed in the benefit plan summary section 212. The user can use the printed copy to fill out paper or electronic enrollment forms and/or can submit the printed copy as a paper enrollment form.

In some embodiments, screens displayed by the benefit enrollment tool 10, such as those described above with respect to FIGS. 3-15, can be customized for a particular plan sponsor and/or a particular participant. For example, screen displayed by the benefit plan enrollment tool 10 can include a logo, trademark, or other identifying symbol of a particular plan sponsor and/or information displayed on the screen can be displayed in language understood by a participant.

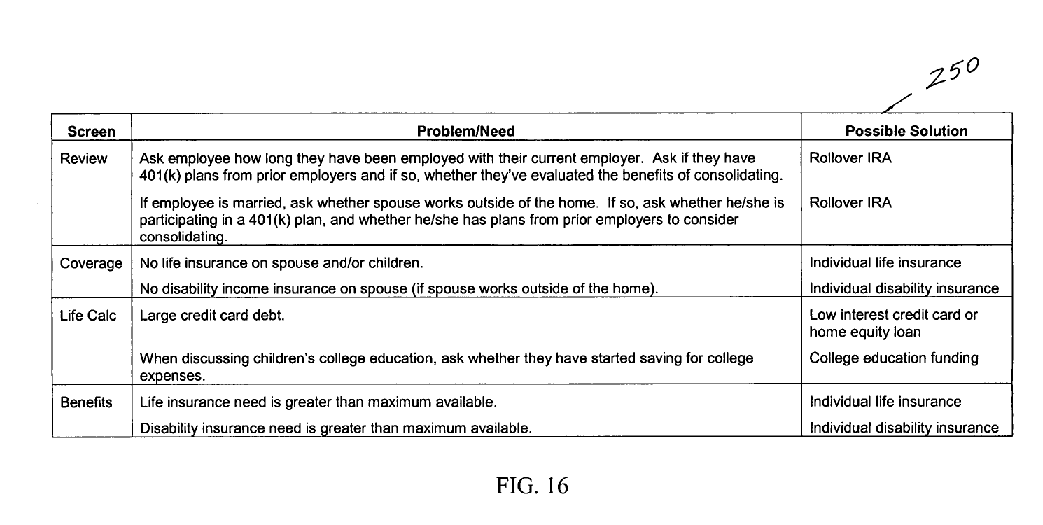

If the representative identifies additional benefit needs and/or financial needs of the participant during the individualized meeting that cannot be met (or met properly) by any of the benefit plans offered by the plan sponsor, the representative can refer the participant to other benefit plans and/or representatives of the plan provider. For example, if the participant has one or more dependents that may want to attend college, the representative can refer the participant to a college savings plan offered by the plan provider. In some embodiments, the representative can refer the participant to another representative of the plan provider who can assist the participant in enrolling in the referred benefit plan. The representative can use a referral worksheet to help identify needs of the participant not met by the benefit plans offered by the plan sponsor. FIG. 16 illustrates a referral worksheet 250 the representative can use to determine opportunities for referring a participant to other insurance and/or financial products and/or associated representatives. In some embodiments, the benefit enrollment tool 10 can perform logic similar to the logic displayed in the referral worksheet 250 to automatically provide a referral to a participant. In some embodiments, the benefit enrollment tool 10 can transfer data regarding the participant and/or the plan sponsor to a representative or related system that will handle the referral.

In some embodiments, the participant can operate the benefit enrollment tool without interacting with the representative. For example, the participant can access the benefit enrollment tool 10 over a network, such as the Internet and can review and provide input to the benefit enrollment tool 10 as described above with respect to FIGS. 2A and 2B. In some embodiments, instructions and guidance typically provided by the representative can be provided to the participant either before or while the participant operates the benefit enrollment tool 10. The instructions and guidance can be provided electronically and/or in hard copy form. The participant can also work with the representative of the plan provider via a telephone while the participant operates the benefit enrollment tool 10. In some embodiments, the representative can shadow the participant's use of the benefit enrollment tool 10 while speaking with the participant over a telephone or other communication connection.

As described above with respect to FIG. 1, the benefit enrollment tool 10 can interact or interface with one or more external devices and/or systems. FIG. 17 illustrates the benefit enrollment tool 10 connected to external devices and/or systems according to embodiments of the invention. As shown in FIG. 17, the benefit enrollment tool 10 can interface with a proposal system 260, a participant information database 270, an administration (“ADMIN”) system 280, and/or a product-related tool 290.

The proposal system 260 generates product quotes and can import quotes to the benefit enrollment tool 10 so that the benefit enrollment tool 10 can display correct products, plan designs, and rates specific to a particular plan sponsor, a participant, a participant's spouse, and/or a participant's dependents.

The participant information database 270 can include a data warehouse interface which can import the participant information provided by the plan sponsor and/or the participant. The participant information can be retrieved from the participant information database 270 at a later date for re-enrollment and/or for tracking and reporting. In some embodiments, the participant information database 270 can store other information such as plan sponsor information and corresponding benefit plan information.

The administration system 280 can manage benefit plan enrollment and management. In some embodiments, the benefit enrollment tool 10 can transmit benefit selections for a particular participant to the administration system 280, and the benefit selections can be automatically and/or manually entered and processed. In some embodiments, the benefit enrollment tool 10 can transmit a participant's benefit selections to the administration system 280 over a network, such as a LAN or the Internet, in order to automatically enroll the participant in the selected benefit plans. Participants can authorize automatic enrollment by digitally signing their enrollment selections and/or performing other security/validation techniques.

The product-related tools 290 can include tools for managing other benefit plans or products offered by the plan provider and/or the plan sponsor. For example, the plan provider can provide a management tool for managing a retirement plan (e.g., a tool that calculates deferrals, maps and tracks retirement goals, etc.) that can interface with the benefit enrollment tool 10 in order to share information. For example, the benefit enrollment tool 10 can provide benefit plan information, participant information, additional benefit plan information, benefit need information, and/or needs priority information to a product-related tool 290 in order to help the product-related tool 290 manage another product owned by and/or offered to the participant. In some embodiments, the product-related tool 290 can provide information to the benefit enrollment tool 10.

The product-related tools 290 can include systems, applications, memory modules, etc. managed by the plan sponsor or a plan sponsor of a participant's spouse. For example, product-related tools 290 can include a participant database or a participant information management system that, in some embodiments, can provide participant information to the benefit enrollment tool 10. If a participant modifies participant information, the benefit enrollment tool 10 can provide modified participant information to the participant database or the participant information management system managed by the plan sponsor or a plan sponsor of a participant's spouse.

In some embodiments, the product-related tools 290 can include tools and/or systems managed by a third-party plan provider. For example, if a plan sponsor provides products and/or plans from multiple plan providers, the product-related tools 290 from multiple plan providers can share information with the benefit management tool 10. In other embodiments, the product-related tools 290 can include tools and/or systems managed by a third-party plan sponsor, such as a plan sponsor associated with a spouse of a participant. The product-related tools 290 can share information with the benefit enrollment tool 10, such as products offered to and products selected by a spouse of a participant.

The product-related tools 290 can include tools and/or systems managed by a participant. For example, the product-related tools 290 can include a budget system managed by a participant that can provide financial information to the benefit enrollment tool 10. The benefit enrollment tool 10 can use the information from the budget system to better determine needs of the participant.

Other types of product-related tools 290 and other external systems can also interface with the benefit enrollment tool 10 by providing information and/or receiving information.

Various features of the invention are set forth in the following claims.

1. A method of enrolling at least one participant in at least one benefit plan, the method comprising:
electronically receiving benefit plan information from a plan sponsor;
electronically providing benefit plan information to the at least one participant;
receiving benefit plan need information from the at least one participant;
receiving needs priority information from the at least one participant; and
electronically providing benefit plan suggestion information to the at least one participant.

2. The method of claim 1 wherein electronically receiving benefit plan information from a plan sponsor includes receiving information about at least one base benefit plan offered by the plan sponsor.

3. The method of claim 1 wherein electronically receiving benefit plan information from a plan sponsor includes receiving information about at least one voluntary benefit plan offered by the plan sponsor.

4. The method of claim 1 further comprising receiving information about the at least one participant.

5. The method of claim 4 wherein receiving information about the at least one participant includes electronically receiving information about the at least one participant from the plan sponsor.

6. The method of claim 4 wherein receiving information about the at least one participant includes receiving information about the at least one participant from the at least one participant.

7. The method of claim 4 further comprising electronically providing the information about the at least one participant to the at least one participant.

8. The method of claim 7 further comprising electronically receiving modified information about the at least one participant from the at least one participant.

9. The method of claim 1 further comprising receiving additional benefit plan information from the at least one participant.

10. The method of claim 9 wherein receiving additional benefit plan information from the at least one participant includes receiving information about whether at least one of the at least one participant, a spouse of the at least one participant, and a dependent of the at least one participant is already enrolled in at least one of a life insurance plan, a disability income insurance plan, and a dental insurance plan.

11. The method of claim 10 wherein receiving information about whether at least one of the at least one participant, a spouse of the at least one participant, and a dependent of the at least one participant is already enrolled in at least one of a life insurance plan, a disability income insurance plan, and a dental insurance plan includes receiving information about an amount of coverage for at least one of the life insurance plan, the disability income insurance plan, and the dental insurance plan.

12. The method of claim 1 further comprising electronically providing statistical information about the at least one benefit plan to the at least one participant.

13. The method of claim 1 wherein receiving benefit plan need information from the at least one participant includes receiving information about expenses to be covered by the at least one benefit plan.

14. The method of claim 1 wherein receiving needs priority information from the at least one participant includes receiving information ranking the importance of receiving a plurality of benefits.

15. The method of claim 1 wherein electronically providing benefit plan suggestion information to the at least one participant includes determining the benefit plan suggestion information based on at least one of the benefit plan information, the benefit plan need information, and the needs priority information.

16. The method of claim 1 wherein electronically providing benefit plan suggestion information to the at least one participant includes electronically providing information about at least one of a benefit amount, a need amount, and a cost amount of the at least one benefit plan.

17. The method of claim 1 further comprising receiving at least one enrollment selection from the at least one participant.

18. The method of claim 17 further comprising electronically providing a summary of the at least one enrollment selection to the at least one participant.

19. The method of claim 17 further comprising enrolling the at least one participant in the at least one benefit plan based on the at least one enrollment selection.

20. The method of claim 1 further comprising establishing a meeting between the at least one participant and a representative of a plan provider.

21. The method of claim 1 further comprising providing a referral to the at least one participant.

22. A computer readable medium including instructions for enrolling at least one participant in at least one benefit plan, the instructions comprising:
receiving benefit plan information from a plan sponsor;
displaying benefit plan information to the at least one participant;
receiving benefit plan need information from the at least one participant;
receiving needs priority information from the at least one participant; and
displaying benefit plan suggestion information to the at least one participant.

23. The computer readable medium of claim 22 wherein instructions for receiving benefit plan information from a plan sponsor includes instructions for receiving information about at least one base benefit plan offered by the plan sponsor.

24. The computer readable medium of claim 22 wherein instructions for receiving benefit plan information from a plan sponsor includes instructions for receiving information about at least one voluntary benefit plan offered by a plan sponsor.

25. The computer readable medium of claim 22 further comprising instructions for receiving information about the at least one participant.

26. The computer readable medium of claim 25 wherein instructions for receiving information about the at least one participant includes instructions for receiving information about the at least one participant from the plan sponsor.

27. The computer readable medium of claim 25 wherein instructions for receiving information about the at least one participant includes instructions for receiving information about the at least one participant from the at least one participant.

28. The computer readable medium of claim 25 further comprising instructions for displaying the information about the at least one participant to the at least one participant.

29. The computer readable medium of claim 28 further comprising instructions for receiving modified information about the at least one participant from the at least one participant.

30. The computer readable medium of claim 22 further comprising instructions for receiving additional benefit plan information from the at least one participant.

31. The computer readable medium of claim 30 wherein instructions for receiving additional benefit plan information from the at least one participant includes instructions for receiving information about whether at least one of the at least one participant, a spouse of the at least one participant, and a dependent of the at least one participant is already enrolled in at least one of a life insurance plan, a disability income insurance plan, and a dental insurance plan.

32. The computer readable medium of claim 31 wherein instructions for receiving information about whether at least one of the at least one participant, a spouse of the at least one participant, and a dependent of the at least one participant is already enrolled in at least one of a life insurance plan, a disability income insurance plan, and a dental insurance plan includes instructions for receiving information about an amount of coverage for at least one of the life insurance plan, the disability income insurance plan, and the dental insurance plan.

33. The computer readable medium of claim 22 further comprising instructions for displaying statistical information about the at least one benefit plan to the at least one participant.

34. The computer readable medium of claim 22 wherein instructions for receiving benefit plan need information from the at least one participant includes instructions for receiving information about expenses to be covered by the at least one benefit plan.

35. The computer readable medium of claim 22 wherein instructions for receiving needs priority information from the at least one participant includes instructions for receiving information ranking the importance of receiving a plurality of benefits.

36. The computer readable medium of claim 22 wherein instructions for displaying benefit plan suggestion information for the at least one benefit plan to the at least one participant includes instructions for determining the benefit plan suggestion information based on at least one of the benefit plan information, the benefit plan need information, and the needs priority information.

37. The computer readable medium of claim 22 wherein instructions for displaying benefit plan suggestion information for the at least one benefit plan to the at least one participant includes instructions for displaying information about at least one of a benefit amount, a need amount, and a cost amount of the at least one benefit plan.

38. The computer readable medium of claim 22 further comprising instructions for receiving at least one enrollment selection from the at least one participant.

39. The computer readable medium of claim 28 further comprising instructions for displaying a summary of the at least one enrollment selection to the at least one participant.

40. The computer readable medium of claim 38 further comprising instructions for enrolling the at least one participant in the at least one benefit plan based on the at least one enrollment selection.

41. The computer readable medium of claim 22 further comprising instructions for providing at least one referral to the at least one participant.

42. A benefit enrollment tool comprising:
an input/output module that obtains benefit plan information, participant information, benefit need information, and needs priority information from at least one external source and provides benefit plan suggestion information to at least one external source;
a memory module that stores the benefit plan information, the participant information, the benefit need information, the needs priority information, and instructions for determining benefit plan suggestion information; and
a processor that obtains the benefit plan information, the participant information, the benefit need information, the needs priority information, and the instructions for determining benefit plan suggestion information, executes the instructions for determining benefit plan suggestion information using at least one of the benefit plan information, the participant information, the benefit need information, and the needs priority information as input, and generates the benefit plan suggestion information.

43. The benefit enrollment tool of claim 42 wherein the benefit plan information includes information about at least one base benefit plan offered by a plan sponsor.

44. The benefit enrollment tool of claim 42 wherein the benefit plan information includes information about at least one voluntary benefit plan offered by a plan sponsor.

45. The benefit enrollment tool of claim 42 wherein the input/output module obtains additional benefit plan information.

46. The benefit enrollment tool of claim 45 wherein the memory module stores the additional benefit plan information.

47. The benefit enrollment tool of claim 45 wherein the additional benefit plan information includes information about whether at least one of at least one participant, a spouse of the at least one participant, and a dependent of the at least one participant is already enrolled in at least one of a life insurance plan, a disability income insurance plan, and a dental insurance plan.

48. The benefit enrollment tool of claim 45 wherein the processor obtains the additional benefit plan information from the memory module and executes the instructions for determining benefit plan suggestion information using the additional benefit plan information as input.

49. The benefit enrollment tool of claim 42 wherein the processor generates statistical information about at least one benefit plan.

50. The benefit enrollment tool of claim 42 wherein the benefit plan need information includes information about expenses to be covered by at least one benefit plan.

51. The benefit enrollment tool of claim 42 wherein the needs priority information includes information ranking the importance of receiving a plurality of benefits.

52. The benefit enrollment tool of claim 42 wherein the input/output module obtains at least one enrollment selection.

53. The benefit enrollment tool of claim 52 wherein the processor generates a summary of the at least one enrollment selection.

54. The benefit enrollment tool of claim 52 wherein the processor enrolls at least one participant in at least one benefit plan based on the at least one enrollment selection.

55. The benefit enrollment tool of claim 52 wherein the input/output module provides the at least one enrollment selection to an administration system.

56. The benefit enrollment tool of claim 42 wherein the input/output module obtains benefit plan information from a proposal system.

57. The benefit enrollment tool of claim 42 wherein the input/output module provides participant information to a participant information database.

58. The benefit enrollment tool of claim 42 wherein the input/output module obtains participant information from a participant information database.

59. The benefit enrollment tool of claim 42 wherein the input/output module obtains information from at least one product-related tool.

60. The benefit enrollment tool of claim 42 wherein the input/output module provides information to at least one product-related tool.

61. The benefit enrollment tool of claim 42 wherein the at least one external source includes a printing mechanism.
